(19) United States
(12) Patent Application Publication
(10) Pub. No.: US 2004/0135320 A1
(43) Pub. Date: Jul. 15, 2004

(54) Sealing ring for sealing a length compensation of a universal joint shaft

(76) Inventor: Hans-Jurgen Schultze, Bottrop (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/624,181

(22) Filed: Jul. 22, 2003

(30) Foreign Application Priority Data
Jul. 26, 2002 (DE) 10234305.5

(51) Int. Cl. F02F 5/00

(52) U.S. Cl. 277/436

(57) ABSTRACT

A sealing ring for sealing the gap between a circular cylindrical outer face of a hub sleeve of a length compensation of a universal joint shaft, the hub sleeve being profiled inside, and a tubular sealing sleeve, covering the outside of the hub sleeve and holding the sealing ring. The sealing ring includes an annular base body having an inner contour, a first leg having in the area of the free end radially inside towards the longitudinal axis a first sealing contour and thereto axially distanced to the free end at least a further sealing contour, and a second leg attached axially along the longitudinal axis, offset to the first leg, on the base body with its connected end and ends with a free end, wherein the second leg in the area of its free end has radially inside towards the longitudinal axis, as the first leg, a first sealing contour and, respectively, axially along the longitudinal axis offset to its connected end at least one further sealing contour.

### BACKGROUND OF THE INVENTION

The invention relates to a sealing ring for sealing the gap between a circular cylindrical outer face of a hub sleeve of a length compensation of a universal joint shaft, the hub sleeve being profiled inside, and a tubular sealing sleeve covering the outside of the hub sleeve and holding the sealing ring.

U.S. Pat. No. 3,942,336 to Schultenkamper discloses an axially movable sealing ring for the length compensation of a universal joint shaft. The sealing ring includes a base body having three legs that extend and are inclined inwardly toward the longitudinal axis. The three legs are directed in the same direction and start offset in the direction of the longitudinal axis on the base body. These legs have, on their free ends, sealing contours in form of annular edges. Of the legs, the outer one with its sealing contour serves as a scraper. The legs arranged behind the outer one serve to achieve a connection as tight as possible. Distanced from the leg forming the scraper, a block-like annular portion, serving for supporting on the outer face of the hub sleeve of the universal joint shaft, is formed on the base body. The form of the legs, and especially the provision of only one annular edge on their free ends, leads to a sealing lip design having only a lower stability, so that a penetration of water and dirt is more easily possible.

### SUMMARY OF THE INVENTION

The invention is based on the object to provide a sealing ring providing a better sealing against penetration of dirt and water into the length compensation and preventing the exiting of grease from the length compensation.

This object is solved by a sealing ring for sealing the gap between a circular cylindrical outer face of a hub sleeve of a length compensation of a universal joint shaft, the hub sleeve being profiled inside, and a tubular sealing sleeve, covering the outside of the hub sleeve and holding the sealing ring, comprising,

an annular base body made from an elastically deformable rubber material and/or plastics, to which means for retaining on the sealing sleeve are arranged, the base body further having a longitudinal axis and an inner contour,

a first leg extending, when seen in a longitudinal cross section, inclined in the untensioned state in relation to the longitudinal axis, starting from an end connected to the base body to a free end, and having in the area of the free end radially inwards in relation to the longitudinal axis a first sealing contour and thereto axially away from the free end at least one further sealing contour, wherein the sealing contours serve to contact the outer face of the hub sleeve,

a second leg which, when seen in a longitudinal cross section, is attached on the base body with its connected end offset along the longitudinal axis to the first leg and which extends inclined with the same direction as the first leg and terminates with a free end, wherein the second leg has in the area of its free end radially inwards towards the longitudinal axis, as the first leg, a first sealing contour and respectively, axially along the longitudinal axis, offset to its connected end, at least one further sealing contour, wherein these sealing contours serve to contact the outer face of the hub sleeve.

The advantage of this solution is that the number of the sealing contours contacting the outer face of the hub sleeve is increased, and that the legs can be formed clearly stiffer, as the contact force is distributed onto a larger number of sealing contours.

Especially by means of the thickening of the legs in the area of the sealing contours, arranged inwards, the escape of grease is more effectively prevented. This means, that a longer lasting grease provision is provided in the length compensation. This means also that less grease can exit, so that also the environmental impact is reduced. The embodiment also ensures that during operation of the universal joint shaft, for example in a commercial vehicle used under off-road conditions or in an earthmoving equipment, the penetration of dirt and water is effectively prevented. At the same time, the ability for lubrication is maintained. For the lubrication, compared to the common design, only a higher lubrication pressure is necessary. This, however, provides the advantage that by means of the later opening of the sealing contours compared to the state of the art, grease is pressed further into the contour of the length compensation and the lubrication thereof and therewith its life span are improved.

Preferably, it is provided that the length of the first leg is, from the end connected to the base body to the free end, longer than the length of the second leg from its end connected to the base body to its free end. This achieves that over a larger tolerance range concerning the diameter of the outer face of the hub sleeve, a sealed contact is achieved.

It is further proposed that the first leg and/or the second leg starting, respectively, from the free end to the connected end, carry on a thickening the further sealing contour(s). Hereby, a reinforcement is achieved, which also leads to better contact conditions. To be able to cover an as large as possible tolerance range in reference to the diameter and thereby to achieve a good sealing, it is further provided that between the sealing contours, an annular recess, respectively, is formed facing away from the longitudinal axis. From the tolerance conditions concerning the diameter of the outer face of the hub sleeve, two or more sealing contours distanced from each other by the recess, or in the extreme case, a facial contact remain.

The sealing contours can have different forms. It is possible to form at least one of the sealing contours as an annular edge in the untensioned state. It is also possible to form at least one of the sealing contours as an annular face in the untensioned state, which is limited in length. It is also possible to round off at least one of the sealing contours, when seen in the longitudinal cross section, in the untensioned state.

To allow the attachment of the sealing ring in the sealing sleeve to be without influence to the sealing function of the sealing contours, so that also materials can be selected having a good sealing characteristic, the base body is provided with a reinforcement ring made from a material differing from the material of the base body. The reinforcement ring is non-detachably connected to the base body and is preferably at least partially embedded therein and is made from metal. By this, it is, on the one hand, possible to ensure a sufficiently large insertion force and therewith a secure fit of the sealing ring in the sealing sleeve, and on the other hand to achieve also the desired conditions concerning the sealing in reference to the outer face of the hub sleeve. This sealing function should not be influenced by the fixing forces of the sealing ring in the sealing sleeve.

In the drawings, a universal joint shaft and different embodiments for the sealing ring according to the invention are represented.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 shows a universal joint shaft, half in front elevational view and half in longitudinal cross section.

FIG. 2 shows a first embodiment of a sealing ring according to the invention in a half longitudinal cross-sectional view, wherein the sealing contours and the legs supporting these, are shown in the untensioned state.

FIG. 3 shows the embodiment of FIG. 2 in application to a hub sleeve having an outer face having a diameter of the lower end of the tolerance range.

FIG. 4 shows the arrangement of the sealing ring of FIG. 2 to a hub sleeve having an outer face, which diameter corresponds to the maximal value of the provided tolerance range.

FIG. 5 shows a half longitudinal cross-sectional view of a second embodiment of a sealing ring according to the invention with several sealing contours per leg.

FIG. 6 shows a third embodiment of a sealing ring according to the invention in a half longitudinal cross-sectional view.

FIG. 7 shows a fourth embodiment of a sealing ring according to the invention in a half longitudinal cross-sectional view.

### DETAILED DESCRIPTION OF THE PREFERRED EMBODIMENTS

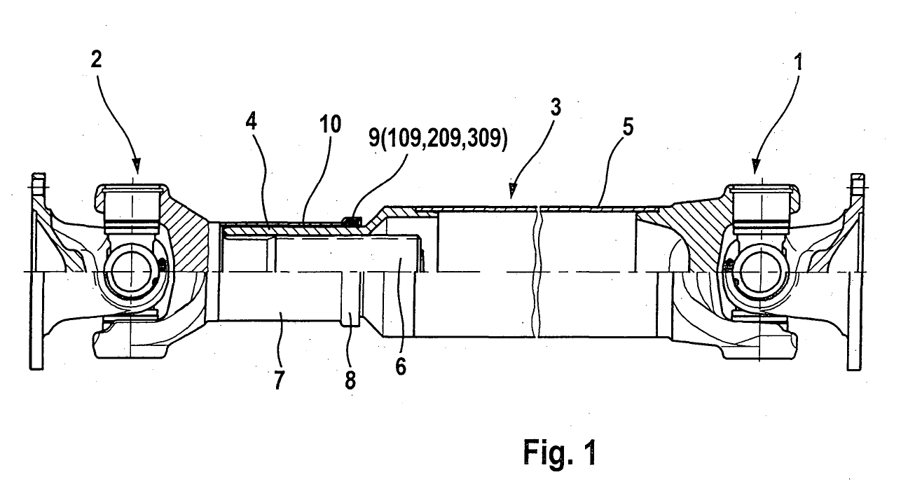

In FIG. 1, a universal joint shaft is represented half in front elevational view and half in longitudinal cross-sectional view.

The universal joint shaft includes a first universal joint 1 and a second universal joint 2, as well as a length compensation 3 connecting the two. The length compensation 3 includes a hub sleeve 4 connected through a tube 5 (which can be formed differently in length for the length adaptation of the universal joint shaft to different applications) to the universal joint 1. The hub sleeve 4 is profiled inside, i.e., it has teeth extending parallel to the longitudinal axis and distributed circumferentially. In the hub sleeve 4, a stub shaft 6, provided with a corresponding toothing, is received displaceably, so that a torque can be transmitted between the two. The stub shaft 6 is fixedly connected to the second universal joint 2. The sliding movement occurring during the operation of the universal joint shaft, when the universal joints 1, 2 do not take up the extended position but work under an inclined condition, necessitates a lubrication of the toothing of the stub shaft 6 and of the hub sleeve 4. To prevent this lubrication grease from exiting this area, and further to prevent humidity or dirt from entering this area, a sealing sleeve 7 is provided. The sealing sleeve 7 is connected fixedly and sealingly at one end to the second universal joint 2 and has, on its other end, a receiving portion 8 enlarged in diameter and serving to take up a sealing ring 9, 109, 209, or 309. This sealing ring serves for the sealing towards the outer face 10 of the hub sleeve 4. It moves during a length change axially on the outer face 10.

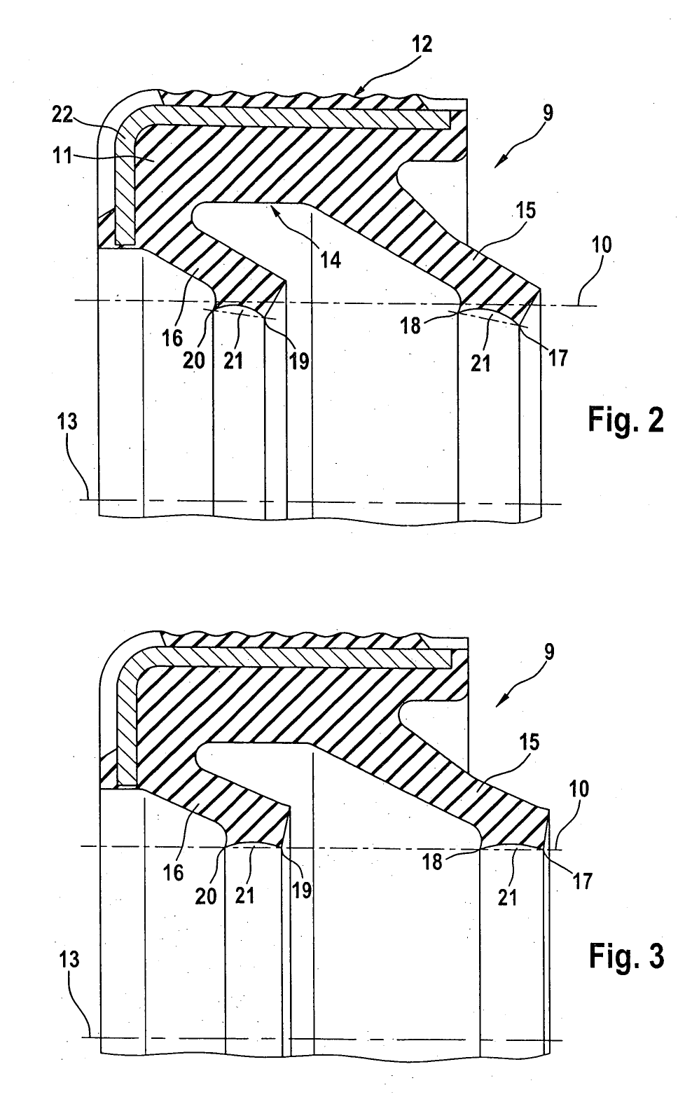

FIGS. 2, 3, and 4 show a first embodiment of a sealing ring 9 in a half longitudinal cross-sectional view. The sealing ring 9 includes a base body 11 made from a rubber material or from plastics or from a compound material. An undulated contour is formed on the outer side 12 of the base body 11, with which the sealing ring 9, for example, is inserted into the receiving portion of the sealing sleeve 7 of FIG. 1. Further, a first leg 15, extending around the longitudinal axis 13 as a conical portion, is formed onto the base body 11, starting from the inner contour 14 projecting inclined in the direction towards the longitudinal axis 13. A second leg 16, extending generally with the same orientation as the first leg 15 toward the longitudinal axis 13, starts from the inner contour 14 of the base body 11 with reference to the longitudinal axis 13, with an axial distance to the first leg 15. The first leg 15 has, on its free end distanced from the end connected to the base body 11, a first sealing contour 17 in form of an annular edge and a second sealing contour 18 in form of an annular edge offset thereto in the direction towards the second leg 16. In the shown untensioned state (i.e., before the sealing ring 9 is installed on the outer face 10 of the hub sleeve 4), a recess 21 exists between the first sealing contour 17 and the second sealing contour 18. Correspondingly, the second leg 16 has, on its free end in the direction toward the first leg 15, a first sealing contour 19, on which axially distanced away from the first leg 15 a second sealing contour 20 in form of an annular edge is attached. A recess 21 exists between the two sealing contours 19 and 20, which are formed as annular edges. Also, the second leg 16 forms a conical body. In FIG. 2, the position of the outer face 10 of the sealing sleeve 7 in reference to the longitudinal axis 13 is illustrated to represent in how far a flaring in the area of the sealing contours 17, 18, 19, 20 have to be provided, so that these can be supported on the outer face 10 of the hub sleeve 4. By this, the corresponding pre-tensioning is determined. Furthermore, it is obvious that the further sealing contours 18 or 20, respectively, of the two legs 15, 16 form part of thickenings of the legs 15, 16, so that a corresponding material concentration is given, which leads to a less elastic behavior. Further, it is visible from FIGS. 2 to 4 that in the base body 11, a reinforcement ring 22, made from a material which differs from the material of the base body and of the attached legs 15, 16, is arranged. Preferably, it is a reinforcement ring 22 made from metal. It ensures, on the one hand, that the sealing ring 9 is accommodated in the receiving portion of the sealing sleeve 7 with the necessary pre-tensioning, i.e. rests fixedly, and, on the other hand, however, that the contact of the sealing contours 17, 18 or 19, 20, respectively, on the outer face remains not influenced thereby.

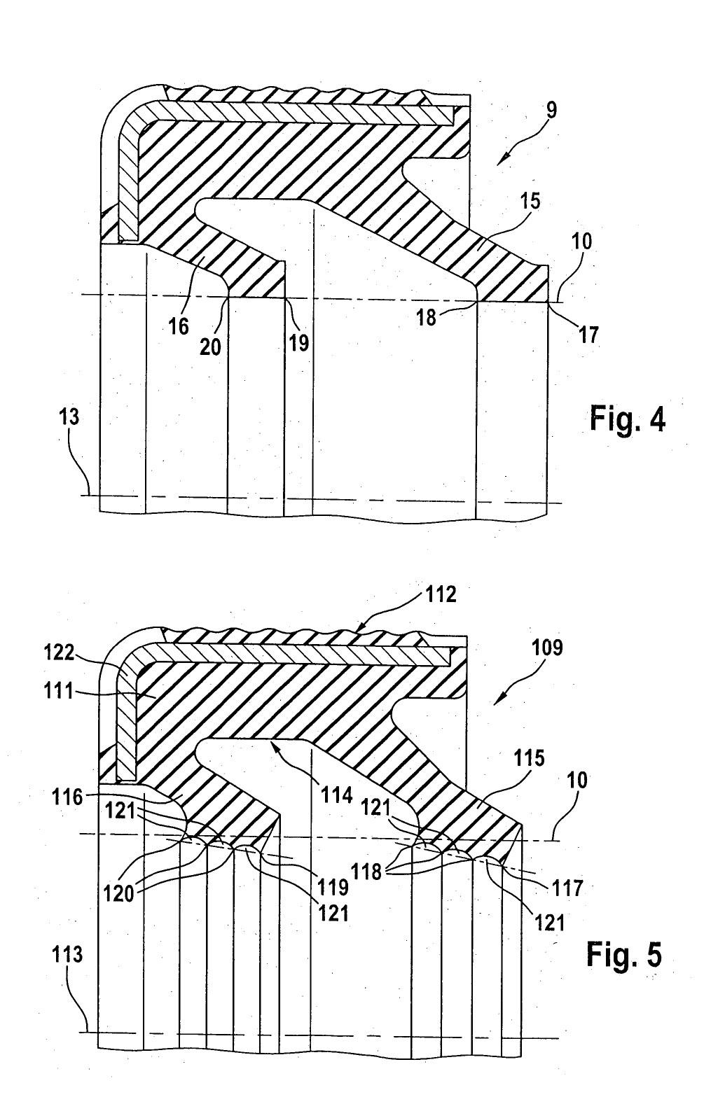

In FIG. 3, the sealing ring 9 is shown as an individual part in a half longitudinal cross-sectional view, wherein, however, the sealing contours 17, 18 and 19, 20, respectively, are shown in such a way as if they would rest on the outer face 10 of the hub sleeve 4, wherein the diameter of the outer face 10 takes up a minimum within the predetermined tolerance range. The sealing contours 17, 18 or 19, 20, respectively, formed as annular edges are also distinctly visible which are in a linear contact to the outer face 10. In the two areas, the recess 21 is still distinctly visible. In FIG. 4, also a half longitudinal cross-sectional view of the sealing ring 9, the shape is illustrated which occurs in the area of the sealing contours 17, 18 and 19, 20 of the two legs 15, 16 when the sealing is mounted on a hub sleeve 4, which outer face 10 takes up, in the predetermined tolerance range, the largest diameter. It is visible, that the sealing contours 17, 18 or 19, 20, respectively, formed originally as annular edges are deformed because of the pre-tensioning in such a way that between the pairs of sealing contours 17, 18 or 19, 20, respectively, no recess is given any more. Therefore, a fit with the highest possible pre-tensioning exists.

FIG. 5 shows a second embodiment of a sealing ring, which is designated with 109. All components and structures which correspond to those of FIG. 2 are provided with reference numerals, which are increased, compared to those of FIG. 2, by the number value 100. For the description, it is referred to the corresponding positions of FIGS. 2 to 4, and only the following differences are described.

The designs of the base body 111 and of the two legs 115, 116 correspond to that of the base body 11 and the legs 15, 16 of FIGS. 2 to 4. On each of the two legs 115, 116, respectively, a first sealing contour 117 and 119, respectively, is provided, which is formed as an annular edge. However, not only one further sealing contour is provided at a distance to the first sealing contour, but there are provided altogether three further sealing contours 118 or 120, respectively, formed respectively as annular edges and are separated from each other by recesses 121. By means of this design, the sealing contact is increased. The deformation characteristics correspond essentially also to those, represented in FIGS. 3 and 4 concerning the embodiment of FIG. 2. The number of sealing contours can be determined according to the requirements.

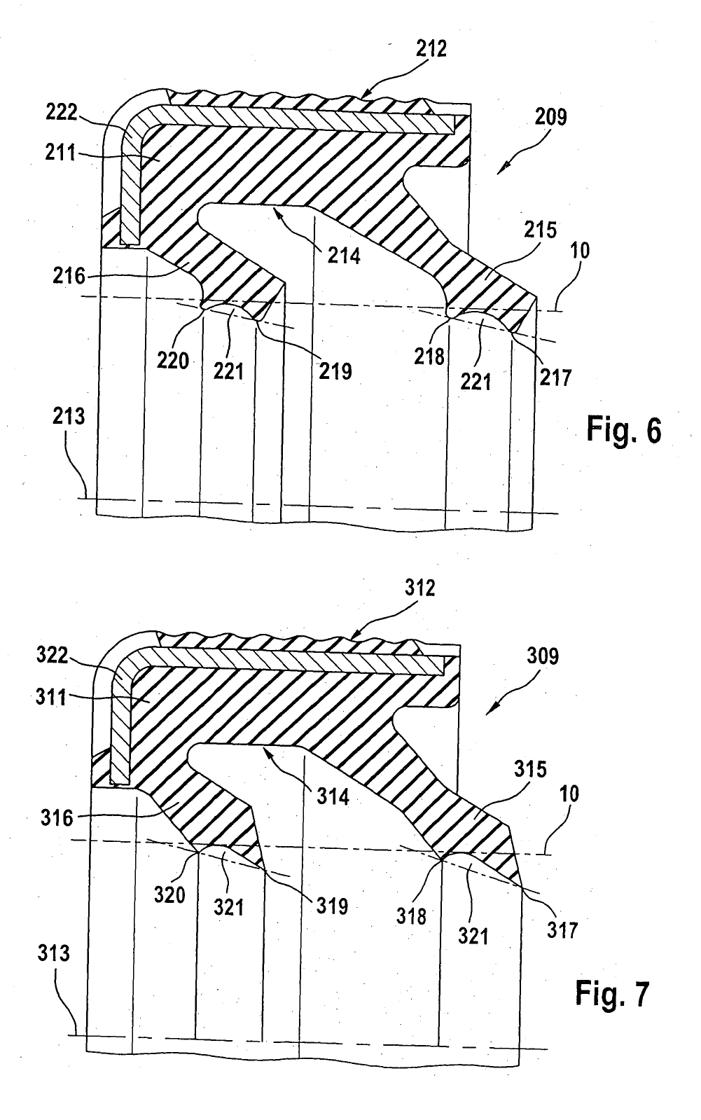

FIG. 6 shows a third embodiment of a sealing ring 209 in a half longitudinal cross-sectional view. Here, the components and structures, which have already been described in connection with FIGS. 2 to 4 for the first embodiment, are provided with reference numerals which, compared to the reference numerals in FIGS. 2 to 4, are increased by the number value 200. For their description, it is referred to the description of the embodiment of FIGS. 2 to 4, and only the following differences are described. In difference to the embodiment of FIGS. 2 to 4, the first sealing contours 217 and 219 of the two legs 215, 216, which are provided in the area of the free end of the two legs 215, 216, are not formed as annular edges, but are provided with a short axial face or a rounding-off. Furthermore, the first leg 215 has a further sealing contour 218, which is provided axially offset to the first sealing contour 217 and is separated therefrom by a recess 212, which is deeper compared to FIG. 2. Furthermore, the second sealing contour 218 is part of a larger thickening of the first leg 215 and has, further, a short axial face or a radius. The same design is provided concerning the sealing contours 219, 220 on the second leg 216.

FIG. 7 shows a half longitudinal cross-sectional view of a sealing ring 309, in which also such components and structures, which correspond to those of the embodiment of FIGS. 2 to 4, are provided with reference numerals which are increased, compared to those of FIGS. 2 to 4, by the number value 300. For their description, it is referred to FIGS. 2 to 4, and only the following differences are described. It can be seen that the free ends of the first leg 315 and the second leg 316 each terminate in a tip, so that a first sealing contour 317 and 319, respectively, is achieved with a distinct annular edge. Further sealing contours 318 and 320 are provided axially offset from these on the longitudinal axis 313 on the first leg 315 and on the second leg 316, which are respectively part of a thickening which is not only, as in the embodiment of FIG. 6, a local thickening, but has a wide base, which leads far in the direction to the end of the two legs 315 and 316, respectively, connected to the base body 311. This is especially significantly provided on the second leg 316. Hereby, an increased stability of the sealing contours contacting the outer face 10 is achieved. Furthermore, an increased contact force is achieved hereby, which is especially advantageous at high rotational speeds.

In the embodiments shown in FIGS. 2 to 7, the sectional face represents part of a rotational body around the respective longitudinal axis.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A sealing ring for sealing a gap between a cylindrical outer face of a hub sleeve of a length compensation of a universal joint shaft and a tubular sealing sleeve covering the outer face of the hub sleeve and holding the sealing ring, the sealing ring comprising:
an annular base body made from an elastically deformable rubber material and/or plastics, to which means for retaining on the sealing sleeve are arranged, the base body further having a longitudinal axis and an inner contour;
a first leg extending inclined, in an untensioned state, in relation to the longitudinal axis, the first leg starting from an end connected to the base body to a free end and having in the area of its free end, inwardly in relation to the longitudinal axis, a first sealing contour and thereto axially away from the free end at least one further sealing contour, wherein the sealing contours serve to contact the outer face of the hub sleeve;
a second leg attached on the base body at a location that is offset along the longitudinal axis to the first leg, the second leg extending inclined in the same direction as the first leg from an end connected to the base body to a free end and having in the area of its free end, inwardly in relation to the longitudinal axis, a first sealing contour and thereto axially along the longitudinal axis, offset to its connected end, at least one further sealing contour, wherein these sealing contours serve to contact the outer face of the hub sleeve.

2. A sealing ring according to claim 1, characterized in that the length of the first leg is, from the end connected to the base body to the free end, longer than the length of the second leg from its end connected to the base body to its free end.

3. A sealing ring according to claim 1, characterized in that the first leg and/or the second leg starting, respectively, from the free end to the connected end, carry on a thickening the further sealing contour(s).

4. A sealing according to claim 1, characterized in that between each of the sealing contours, an annular recess is formed facing away from the longitudinal axis.

5. A sealing ring according to claim 1, characterized in that at least one of the sealing contours is formed as an annular edge in the untensioned state.

6. A sealing ring according to claim 1, characterized in that at least one of the sealing contours is formed as an annular face in the untensioned state.

7. A sealing ring according to claim 1, characterized in that at least one of the sealing contours is rounded off, when seen in longitudinal cross section, in the untensioned state.

8. A sealing ring according to claim 1, characterized in that the base body is non-detachably connected to a reinforcement ring made from a material different from the material of the base body.

9. A sealing ring according to claim 8, characterized in that the reinforcement ring is at least partially embedded in the base body.

10. A sealing ring according to claim 8, characterized in that the reinforcement ring is made from metal.
